(19) United States
(12) Patent Application Publication
(10) Pub. No.: US 2014/0231674 A1
(43) Pub. Date: Aug. 21, 2014

(54) INK JET PRINTER COMPOSITION AND USE

(71) Applicant: Wayne Lee Cook, Xenia, OH (US)

(72) Inventor: Wayne Lee Cook, Xenia, OH (US)

(21) Appl. No.: 13/769,504

(22) Filed: Feb. 18, 2013

(51) Int. Cl. C09D 11/00; G01N 21/64; B42D 15/00; B41J 2/02

(52) U.S. Cl. CPC C09D 11/326; B41J 2/02; G01N 21/64; B42D 15/00
USPC 250/459.1; 252/301.16; 252/301.35; 347/9; 428/207

(57) ABSTRACT

An aqueous ink jet printer ink composition is designed for ink jet printing of fluorescent images. This composition contains fluorescent pigment particles that have (1) an excitation peak wavelength of at least 300 nm and less than 400 nm, and (2) an emission peak that is greater than 400 nm and up to and including 700 nm when exposed to fluorescent-exciting radiation. The non-polymeric fluorescent pigment particles have a median particle size that is greater than 10 nm and up to and including 500 nm, and the 95^{th} percentile fluorescent pigment particle size is less than 150 nm. The composition can be continuously printed on various pretreated or untreated receiver elements or articles to provide a fluorescent image that can be detected when excited at the appropriate wavelength. The fluorescent image can thus be used as a security or identification mark for various purposes.

### FIELD OF THE INVENTION

This invention relates to an aqueous ink jet composition comprising fluorescent pigments, which composition is particularly useful for continuous ink jet printing. This invention also relates to methods for using the aqueous ink jet printer ink composition in ink jet printing to provide printed images that are undetectable until irradiated with ultraviolet light. Moreover, the invention provides receiver elements that comprise the printed fluorescent image.

### BACKGROUND OF THE INVENTION

Ink jet printing systems are generally of two types: drop-on-demand (DOD) printing systems and continuous ink jet (CIJ) printing systems. Inkjet printing is a standard method for printing an image onto a substrate wherein a stream of ink droplets are directed from a printing device to a surface of a suitable receiver element or substrate. The direction of the stream of droplets is controlled electronically in causing the droplets to print the desired image or information on the substrate surface without requiring contract between the printing device and the surface to which the ink is applied. Objects, comprising substrates to which ink jet printing is well suited include but are not limited to, containers for consumer products, currency, draft checks, envelopes, letterhead, identification cards, lottery tickets, bank cards, identification strips, labels, and other well known materials.

Drop-on-demand printing systems are widely used in home or consumer ink jet printers and slower consumer printers, both of which have been available for several decades. As the name implies, this type of ink jet printing uses a print head that ejects drops of ink only when signaled to do so by a digital controller. However, such DOD printing systems are relatively slow as the print heads are slow and thus such systems are undesirable for high-speed, web (roll)-fed printing needs.

CIJ printing systems generally comprise two main components, a fluid system (including an ink reservoir) and one or more print heads. Ink can be pumped through a supply line from the ink reservoir to a manifold that distributes the ink to a plurality of orifices, typically arranged in linear array(s), under sufficient pressure to cause ink streams to issue from the orifices of the print head(s). Stimulations can be applied to the print head(s) to cause those ink streams to form streams of uniformly sized and spaced drop, which are deflected in a suitable manner, into printing or non-printing paths. Non-printing drops are returned to the ink reservoir using a drop catcher and a return line. Thus, in contrast to DOD printing systems, CIJ printing systems involves use of a continuous stream of ink drops that are separated to discriminate between printing drops and non-printing drops. This discrimination can be accomplished by electrostatically charging the drops and passing the charged drops through an electric field. Charged drops are deflected by a charge field and can be caught and returned to the reservoir of ink. Uncharged drops are printed on a substrate or receiver material. Some useful CIJ printing apparatus and print head fabrication are described for example in U.S. Pat. No. 6,588,888 (Jeanmaire et al.) and U.S. Pat. No. 6,943,037 (Anagnostopoulos et al.).

More recent innovations in CIJ printing systems include the use of silicon print head nozzles with heaters built into them. These print head nozzles respond to an electronic signal and change the physical characteristics of drops being ejected. Heated drops “catch up” in velocity with non-heated drops in the emission space. Multiple drops can combine to form a “printed drop” that is printed onto the substrate or receiver material. Single drops can be caught by an air stream and returned to the ink reservoir for use a future use.

Commercially available CIJ inks are mostly aqueous dye-based inks that exhibit a number of problems. In such dye-based inks, no particles are observable under the microscope. Although there have been many recent advances in the art of dye-based ink jet inks, such inks still suffer from deficiencies such as low optical densities on coated glossy paper and poor light-fastness. When water is used as the carrier, such inks also generally suffer from poor water fastness and poor smear resistance.

Colored pigment-based inks have been proposed as a means of addressing limitations of dye based inks. In pigment-based inks, the colorant exists as discrete particles. Pigment dispersions known in the art include self-dispersing pigment dispersions, dispersant stabilized pigment dispersions and encapsulated pigment dispersions. For non-self-dispersive pigments, the pigment particles are usually treated with addenda known as dispersants or stabilizers that serve to keep the pigment particles from agglomerating or settling out. Useful pigment-based inks for CIJ printing systems are described for example in U.S. Patent Application Publications 2010/0304028 (Sowinski et al.) and 2011/0122180 (Cook et al.).

In general, such pigment-based inks can comprise a wide variety of colored pigments that can be chosen depending upon the specific application and performance requirements for the printing system and desired printing results. For example, such pigments can include but are not limited to, carbon black or other black pigments, red pigments, yellow pigments, and blue pigments. The printed images using such pigment-based inks are generally desired to have a visual density of at least 0.5.

Security marking is becoming increasingly important for various purposes, that is, a means for marking documents, clothing, or product labels with a “security” tag. Particles including electrophotographic toners have been used for this purpose. For example, documents have been labeled for authentication using a toner particle containing two or more mixed compounds having a characteristic detectable signal.

Product counterfeiting occurs in artworks, CD's, DVD's, computer software recorded on various media, perfumes, designer clothes, handbags, luggage, automobile and airplane parts, securities (for example stock certificates), identification cards (for example, drivers' licenses, passports, visas, and green cards), voting ballots, lottery tickets, currency, credit and debit cards, smart cards, and pharmaceuticals. The application of a security marker or taggant to an object or product for authenticating the origin or intended market is known in the art and increasing in importance. Security markers can be incorporated into components that make up the object or product, or they can be incorporated into papers, inks, or varnishes that are applied to the object or product, or they can be incorporated into labels affixed to the object, product, or packaging there for. The presence of the security marker can be used to verify the authenticity of the origin of the object using suitable detection means that is specific to the security marker.

Some systems used for detecting the security markers are often known as “forensic” systems because they tend to require sophisticated equipment (for example high power microscopes) in a laboratory analysis. Other detection systems are designed for “field” use and are known as “covert” systems as they can be used outside the laboratory with specially designed equipment for the specific security markers being detected.

Some security markers can be dispersed within a carrier varnish and are referred to as pigment-based markers. Such markers remain intact in the varnish and will appear as particles when examined microscopically. Other security markers are dissolvable in an ink or varnish and distributed in the carrier on a molecular level. These markers are not readily detected with a microscope and require more sophisticated detection equipment.

While electrophotographic toner particles comprising various taggants within the polymeric matrix have been used for these security purposes as described for example in U.S. Pat. No. 8,110,628 (Nair et al.), it would be desirable to use fluorescent dyes and pigments without being encapsulated within polymeric particles. However, fluorescent dyes are typically water-soluble or water-dispersible and have the problems of water bleeding and poor light fastness. Some pigments can fluoresce but are also visibly colored or unsuitable for dispersion into ink jet ink compositions.

Fluorescent inks comprising water-soluble dyes have been developed for printing a “security mark” on articles such that the security mark is invisible to the unaided eye, but that can be detected as fluorescence upon excitation with an activating light of a suitable excitation wavelength spectrum. More particularly, invisible security marks can be applied to articles in efforts to prevent forgery, theft, and fraud, particularly for identification cards, passports, currency, checks, securities, and other types of commercial paper or identification means. The security mark can be in the form of a barcode that encodes information in a recognizable pattern for identification and verification purposes.

Various water-soluble fluorescent dyes are used in ink jet printing compositions, and perhaps they have been used for security marking purposes. Such water-soluble dyes are described for example in U.S. Patent Application Publications 2003/0041774 (Auslander et al.), 2004/0241424 (Barbera-Guillem), 2005/0279248 (Auslander), and 2006/0293409 (Sanchez et al.), and U.S. Pat. No. 6,793,723 (Auslander et al.) and U.S. Pat. No. 6,905,538 (Auslander). However, water-soluble fluorescent dyes generally exhibit poor light fast stability and dye images are prone to bleeding on printed images. Fluorescent-wax emulsions are described for ink jet compositions are described in U.S. Patent Application Publication 2009/0038507 (Akers Jr. et al.).

U.S. Pat. No. 8,349,211 (Cai) describes fluorescent inkjet compositions including a fluorescent dispersion that is said to have improved shelf life under exposure to heat. The fluorescent colorants used in this fluorescent dispersion can have a wide range of particle sizes with no particularly defined particle size distribution.

However, there is a need to find non-bleeding and light fast security fluorescent marking materials that can be readily applied using ink jet printing methods and are detectable on printed articles using suitable UV irradiation. It is particularly desirable that such fluorescent marking materials be applicable to various receiver elements using continuous ink jet printing systems and therefore have a median particle size and particle size distribution that is most conducive to such ink jet printing systems.

### SUMMARY OF THE INVENTION

The present invention provides an aqueous inkjet printer ink composition consisting essentially of:

non-polymeric fluorescent pigment particles that have (1) an excitation peak wavelength of at least 300 nm and less than 400 nm, and (2) an emission peak wavelength that is greater than 400 nm and up to and including 700 nm when exposed to fluorescent-exciting radiation, and

an aqueous medium comprising water,

wherein the non-polymeric fluorescent pigment particles have a median particle size that is greater than 10 nm and up to and including 500 nm, and the 95^{th} percentile fluorescent pigment particle size is less than 150 nm.

In some embodiments of the present invention, the aqueous inkjet printer ink composition consists essentially of:

non-polymeric fluorescent pigment particles that have (1) an excitation peak wavelength of at least 300 nm and less than 400 nm, and (2) an emission peak wavelength that is greater than 400 nm and up to and including 700 nm when exposed to fluorescent-exciting radiation,

one or more colored non-fluorescent pigments other than carbon black, having a median particle size of at least 10 nm and up to and including 200 nm, and

an aqueous medium comprising water,

wherein the non-polymeric fluorescent pigment particles have a median particle size that is greater than 10 nm and up to and including 500 nm, and the 95^{th} percentile fluorescent pigment particle size is less than 150 nm.

In addition, a method of this invention comprises a method of inkjet printing, comprising:

providing a main fluid supply of the aqueous ink jet printer ink composition of any embodiment of this invention,

pumping the aqueous ink jet printer ink composition from the main fluid supply to a drop generator mechanism, and ejecting a continuous stream of the aqueous inkjet printer ink composition from the drop generator mechanism, which continuous stream is broken into spaced drops, and

in response to electrical signals received from a control mechanism, controlling the spaced drops to differentiate between printing drops for marking a receiver element and non-printing drops that are collected and returned to the main fluid supply.

In other embodiments of this invention, a method for forming an image comprises ink jet printing a receiver element with the aqueous ink jet printer ink composition of any embodiment of this invention, using an ink jet printer. In some of these embodiments, the method further comprises continuously recirculating unused aqueous ink jet printer ink composition to the ink jet printer.

The method of this invention can provide a receiver element of this invention, which has thereon an inkjet printed image comprising non-polymeric fluorescent pigment particles that have (1) an excitation peak wavelength of at least 300 nm and less than 400 nm, and (2) an emission peak wavelength that is greater than 400 nm and up to and including 700 nm when exposed to fluorescent-exciting radiation.

The present invention also provides a method of detecting a fluorescent image on an article, the method comprising:

irradiating an article with radiation having a peak wavelength of at least 300 nm and up to and including 400 nm, the article comprising an ink jet printed colorless image obtained using an aqueous ink jet printer ink composition of any embodiment of this invention.

Several advantages are achieved using the present invention. Articles or substrates can be inkjet printed with colorless or colored “inks” or compositions that can be detected only by making the ink or composition fluoresce under specific conditions. The fluorescent composition can be used as water-fast and light-fast taggants or security detection means on various substrates or articles.

In many embodiments of this invention, the non-polymeric fluorescent pigment particles used in the practice of this invention are designed with specific small particle sizes (nano-particles) in pigment dispersions that are useful particularly in a recirculating continuous inkjet (CIJ) apparatus and ink jet printing methods. In addition, the non-polymeric fluorescent pigment particles have a desired particle size distribution that makes CIJ printing more readily possible, for example, because the 95^{th} percentile fluorescent pigment particle size is less than 150 nm.

The present invention also utilizes fluorescent pigments that exhibit improved water fastness and light fastness over the use of fluorescent dyes that have a tendency to “bleed” after application to a receiver element. Receiver elements that are printed using the present invention can be untreated or pretreated using compositions that enhance the quality of the resulting ink jet printed fluorescent image.

### DETAILED DESCRIPTION OF THE INVENTION

### Definitions

As used herein to define various components of the aqueous ink jet printer ink composition, unless otherwise indicated, the singular forms “a”, “an”, and “the” are intended to include one or more of the components (that is, including plurality referents).

Each term that is not explicitly defined in the present application is to be understood to have a meaning that is commonly accepted by those skilled in the art. If the construction of a term would render it meaningless or essentially meaningless in its context, the term's definition should be taken from a standard dictionary.

The use of numerical values in the various ranges specified herein, unless otherwise expressly indicated otherwise, are considered to be approximations as though the minimum and maximum values within the stated ranges were both preceded by the word “about”. In this manner, slight variations above and below the stated ranges can be used to achieve substantially the same results as the values within the ranges. In addition, the disclosure of these ranges is intended as a continuous range including every value between the minimum and maximum values.

Unless otherwise indicated, the terms “aqueous ink jet printer ink composition”, “ink composition”, and “composition” are meant to refer to embodiments of the present invention.

The term “non-polymeric fluorescent pigment particles” is meant to refer to fluorescent pigment particles that are not attached to, incorporated into, or encapsulated by, organic polymers to any appreciable extent. It is not the intent of this invention to use fluorescent pigment particles that are connected in any manner to organic polymers. As fluorescent pigment particles, they are virtually insoluble in water in contrast to water-soluble fluorescent dyes.

### Aqueous Ink Jet Printer Ink Compositions

In some embodiments of this invention, the aqueous ink jet printer ink composition of the invention consists essentially of non-polymer fluorescent pigment particles described below, and an aqueous medium comprising water. These are the only critical components to provide the desired fluorescent properties. Other optional components described can be present also to enhance or optimize various properties. The compositions of these embodiments typically comprise at least 80 weight % water, or at least 90 weight %, based on total composition weight.

In other embodiments of this invention, the aqueous ink jet printer ink composition of this invention consists essentially of non-polymer fluorescent pigment particles described below, colored non-fluorescent pigment particles other than carbon black as described below, and an aqueous medium comprising water. The compositions of these embodiments typically comprise at least 75 weight % water, or at least 85 weight %, based on total composition weight.

A wide variety of non-polymeric fluorescent pigment particles can be used as long as they have an excitation peak wavelength of at least 300 nm and less than 400 nm, or more likely of at least 320 nm and up to and including 380 nm. Thus, they are readily excited generally by ultraviolet irradiation. As a result of this irradiation, the pigments emit at an emission peak wavelength that is greater 400 nm and up to and including 700 nm. Thus, while many of the non-polymeric fluorescent pigment particles are colorless (invisible), meaning they essentially non-absorbing between 400 nm and 700 nm, the emission peak wavelength can be in the blue, green, or red regions of the electromagnetic spectrum. The emission can occur at multiple wavelengths as long as there is at least one peak wavelength designed to be detected. Thus, some of the non-polymeric fluorescent pigments used in this invention can emit in the red region of the spectrum, that is of at least 600 nm and up to and including 700 nm, while others can emit the blue region (for example, at least 400 nm and up to and including 500 nm), or still others in the green region (for example, at least 500 nm and up to and including 600 nm). Other non-polymeric fluorescent pigment particles are visibly colored.

The non-polymeric fluorescent pigment particles generally have a median particle size that is greater than 10 nm and up to and including 500 nm or typically greater than 10 nm and up to and including 200 nm. More particularly, when used in continuous ink jet systems and methods that utilize ink recirculation, the median particle size is at least 10 nm and up to and including 100 nm. Moreover, the 95^{th} percentile non-polymeric fluorescent pigment particle size is less than 150 nm. The median particle size and 95^{th} percentile particle size are determined using a Nanotrac Particle Size Analyzer (manufactured by Microtrac) using methods defined by the instrument manufacturer. Particles sizes can also be measured using Malvern or Horiba particle size analysis instruments using known procedures.

Thus, in some particularly useful embodiments, the non-polymeric fluorescent pigment particles have an excitation peak wavelength of at least 320 nm and less than 380 nm, and have an emission peak wavelength of that is greater than 400 nm and up to and including 700 nm when exposed to fluorescent exciting radiation.

In some embodiments, the non-polymeric fluorescent pigment particles described herein are the only pigment particles in the aqueous ink jet printer ink composition, while in other embodiments, the composition can also include one or more colored pigments (described below).

Other embodiments of the aqueous ink jet printer ink composition of this invention include two or more distinct non-polymeric fluorescent pigment particles, the distinct non-polymeric fluorescent pigment particles having either:

(a) the same excitation peak wavelength of at least 300 nm and less than 400 nm, and different emission peak wavelengths that are greater than 400 nm and up to and including 700 nm when exposed to fluorescence-exciting radiation, or

(b) different excitation peak wavelengths that are at least 300 nm and less than 400 nm, and the same emission peak wavelength that is greater than 400 nm and up to and including 700 nm when exposed to fluorescence-exciting radiation.

Useful non-polymeric fluorescent pigment particles can have various chemical compositions that would be known to skilled color chemists and are described in the Pigment Handbook, Temple C. Patton (Ed.), Wiley-Interscience, Vol. I, pp. 907-910, and Vol. II, pp. 892-903, 1973. Some useful commercial non-polymeric fluorescent pigment particles are available from Day-Glo Corporation (Cleveland, Ohio), Keystone Aniline Corporation (Chicago, Ill.), and Luminochem (Budapest, Hungary).

One or more different types of non-polymeric fluorescent pigment particles are present in the aqueous ink jet print ink composition in an amount of at least 0.1 weight % and up to and including 10 weight %, or typically of at least 0.3 weight % and up to and including 5 weight %.

Some embodiments of the aqueous ink jet printer ink composition of this invention can also comprise one or more colored, non-fluorescent pigment particles other than carbon black. Such color pigments can be used to provide a visible image of a desired color or hue. By “non-fluorescent”, it is meant that such colored pigments do not fluoresce when irradiated at a wavelength of at least 300 nm to and including 400 nm to any appreciable extent so that the fluorescing effect of the fluorescent pigment particles in the composition are not diminished by more than 5% compared to irradiating the same composition absent the color pigments at the same wavelength.

A wide variety of organic and inorganic colored non-fluorescent pigments can be used in this manner in some embodiments. For example, useful colored non-fluorescent pigments include but are not limited to those disclosed in, for example, U.S. Pat. No. 5,026,427 (Mitchell et al.), U.S. Pat. No. 5,085,698 (Ma et al.), U.S. Pat. No. 5,141,556 (Matrick), U.S. Pat. No. 5,160,370 (Suga et al.), and U.S. Pat. No. 5,169,436 (Matrick), the disclosures of which are incorporated herein by reference for the purpose of describing such pigments. The exact choice of colored non-fluorescent pigments will depend upon the specific application and performance requirements such as color reproduction and image stability in the resulting ink jet printer images. For example, colored non-fluorescent pigment particles (usually in dispersed form) can be present in the aqueous ink jet printer ink compositions in an amount of at least 0.1 weight % and up to and including 10 weight % and more typically in an amount of at least 0.3 weight % and up to and including 5 weight %.

Colored pigments suitable for inclusion in the aqueous ink jet printer ink composition of this invention include, but are not limited to, azo pigments, monoazo pigments, di-azo pigments, azo pigment lakes, β-Naphthol pigments, Naphthol AS pigments, benzimidazolone pigments, di-azo condensation pigments, metal complex pigments, isoindolinone and isoindoline pigments, polycyclic pigments, phthalocyanine pigments, quinacridone pigments, perylene and perinone pigments, thioindigo pigments, anthrapyrimidone pigments, flavanthrone pigments, anthanthrone pigments, dioxazine pigments, triarylcarbonium pigments, quinophthalone pigments, diketopyrrolo pyrrole pigments, and titanium oxide. Carbon black and other “black” color pigments are excluded or not purposely added to the composition. Some of these colored pigments are generally non-fluorescent although some pigments may have some inherent fluorescing capability but not sufficiently to be useful as a fluorescent security mark according to the present invention.

While some of the non-polymeric fluorescent pigment particles are self-dispersing within the aqueous medium in the composition, in many embodiments, the aqueous ink jet printer ink composition of this invention is designed so that the non-polymeric fluorescent pigment particles are dispersed in the presence of a dispersant that is present in an amount sufficient to provide a weight ratio of the dispersant to the non-polymeric fluorescent pigment particles of at least 1:4 and to and including 1:2, or typically of at least 1:4 and up to and including 1:3.

The aqueous ink jet printer ink compositions of this invention can be prepared by any method known in the art of ink jet printing. Useful methods commonly involve two steps: (a) a dispersing or milling step to break up the non-polymeric fluorescent pigments to primary particles, where primary particle is defined as the smallest identifiable subdivision in a particulate system, and (b) a dilution step in which the non-polymeric fluorescent pigment dispersion from step (a) is diluted with the remaining ink components to give a working strength composition. The milling step (a) is carried out using any type of grinding mill such as a media mill, a ball mill, a two-roll mill, a three-roll mill, a bead mill, and air jet mill, an attritor, or a liquid interaction chamber. In the milling step (a), non-polymeric fluorescent pigments are optionally suspended in an aqueous medium that is typically the same as or similar to the aqueous medium used to dilute the pigment dispersion in step (b). Inert milling medium is optionally present in the milling step (a) in order to facilitate break-up of the non-polymeric fluorescent pigments to primary fluorescent particles. Inert milling media include such materials as polymeric beads, glasses, ceramics, metals and plastics as described, for example, in U.S. Pat. No. 5,891,231 (Gnerlich et al.) the disclosure of which is incorporated herein by reference. The milling media described in this patent is particularly useful to obtain pigment dispersion of finer particle size. Milling media are removed from either the non-polymeric fluorescent pigment dispersion obtained in step (a) or from the ink jet printer ink composition obtained in step (b).

A dispersant is optionally present in the milling step (a) in order to facilitate break-up of the non-polymeric fluorescent pigments into primary fluorescent particles. For the non-polymeric fluorescent pigment dispersion obtained in step (a) or the ink jet printer ink composition obtained in step (b), a dispersant is optionally present in order to maintain particle stability and prevent settling. Dispersants suitable for use in the invention include, but are not limited to, those commonly used in the art of inkjet printing. Particularly useful dispersants include anionic, cationic or nonionic surfactants such as sodium dodecylsulfate, or potassium or sodium oleylmethyltaurate as described in, for example, U.S. Pat. No. 5,679,138 (Bishop et al.), U.S. Pat. No. 5,651,813 (Santini et al.), or U.S. Pat. No. 5,985,017 (Bugner et al.), the disclosures of which are incorporated herein by reference.

Polymeric dispersants are also useful and can be added to the non-polymeric fluorescent pigment dispersion prior to, or during the milling step (a), and include polymers such as homopolymers and copolymers; anionic, cationic or nonionic polymers, or random, block, branched, or graft polymers. Polymeric dispersants useful in the milling operation include random and block copolymers having hydrophilic and hydrophobic portions as described for example in U.S. Pat. No. 4,597,794 (Ohta et al.), U.S. Pat. No. 5,085,698 (Ma et al.), U.S. Pat. No. 5,519,085 (Ma et al.), U.S. Pat. No. 5,272,201 (Ma et al.), U.S. Pat. No. 5,172,133 (Suga et al.), U.S. Pat. No. 6,043,297 (Sano) and WO 2004/111140A1 (Spinelli), and graft copolymers described for example in U.S. Pat. No. 5,231,131 (Chu et al.), U.S. Pat. No. 6,087,416 (Pearlstine et al.), U.S. Pat. No. 5,719,204 (Beach et al.), and U.S. Pat. No. 5,714,538 (Beach et al.), the disclosures of which were incorporated herein by reference. Typically, these polymeric resins are copolymers made from hydrophobic and hydrophilic monomers. The copolymers are designed to act as dispersants for the fluorescent pigments by virtue of the arrangement and proportions of hydrophobic and hydrophilic monomers. The non-polymeric fluorescent pigment particles are stabilized by steric and ionic effect of the dispersant and can be referred to as a polymer-dispersed non-polymeric fluorescent pigment dispersion. Polymer stabilized non-polymeric fluorescent pigment dispersions have the additional advantage of offering image durability once the printed inks are dried down on a receiver element.

Polymeric dispersants, typically copolymers, are not limited in the arrangement of the monomers comprising the copolymer. The arrangement of monomers may be totally random, or they can be arranged in blocks such as AB or ABA wherein, A is the hydrophobic monomer and B is the hydrophilic monomer. In addition, the polymer can take the form of a random terpolymer or an ABC tri-block wherein, at least one of the A, B and C blocks is chosen to be the hydrophilic monomer and the remaining blocks are hydrophobic blocks dissimilar from one another.

Especially useful copolymer dispersants are those where the hydrophobic monomer is selected from benzyl methacrylate or acrylate, or from methacrylic or acrylic acid esters containing an aliphatic chain having twelve or more carbons, which aliphatic chains may be linear or branched. Examples of methacrylic and acrylic acid esters having twelve or more carbons include but are not limited to, lauryl acrylate, lauryl methacrylate, tridecyl acrylate, tridecyl methacrylate, tetradecyl acrylate, tetradecyl methacrylate, cetyl acrylate, iso-cetyl acrylate, stearyl methacrylate, iso-stearyl methacrylate, stearyl acrylate, stearyl methacrylate, decyltetradecyl acrylate, and decyltetradecyl methacrylate. Particularly useful are stearyl or lauryl methacrylate or acrylate. The hydrophobic portion of the polymer can be prepared from one or more of the hydrophobic monomers.

Particularly useful copolymer dispersants are those where the hydrophilic monomer is selected from carboxylated monomers and are prepared from at least one hydrophilic monomer that is an acrylic acid or methacrylic acid monomer, or combinations thereof. Useful polymeric pigment dispersants are further described in U.S. Patent Application Publications 2006/0012654 (Wang et al.) and 2007/0043144 (House et al.), the disclosures of which are incorporated herein by reference.

Typically, the weight average molecular weight of a useful copolymer dispersant is less than 50,000 Daltons and can be even less than about 25,000 Daltons, and of at least 500 Daltons.

Encapsulating type polymeric dispersants and polymeric dispersed non-polymeric fluorescent pigments thereof can also be used in the invention. Specific examples are described in U.S. Pat. No. 6,723,785 (Hama et al.) and U.S. Pat. No. 6,852,777 (Nakano et al.), U.S. Patent Application Publications 2004/0132942 (Sakakibara et al.), 2005/0020731 (Tanaka et al.), 2005/0075416 (Miyabayashi), 2005/0124726 (Yatake et al.), and 2005/0124728 (Komatsu et al.), the disclosures of which are incorporated herein by reference. Encapsulating type polymeric dispersants can be especially useful because of their high dispersion stability on keeping and low degree of interaction with ink components.

Self-dispersing non-polymeric fluorescent pigments that are dispersible without the use of a dispersant or surfactant also can be used in the invention. Non-polymeric fluorescent pigments of this type are those that have been subjected to a surface treatment such as oxidation/reduction, acid/base treatment, or functionalization through coupling chemistry. The surface treatment can render the surface of the non-polymeric fluorescent pigment particles with anionic, cationic or non-ionic groups such that a separate dispersant is not necessary. The preparation and use of covalently functionalized self-dispersed non-polymeric fluorescent pigments suitable for inkjet printing are described in U.S. Pat. No. 6,758,891 (Bergemann et al.) and U.S. Pat. No. 6,660,075 (Bergemann et al.), U.S. Pat. No. 5,554,739 (Belmont), U.S. Pat. No. 5,707,432 (Adams et al.), U.S. Pat. No. 5,803,959 (Johnson et al.), U.S. Pat. No. 5,922,118 (Johnson et al.), U.S. Pat. No. 5,837,045 (Johnson et al.), U.S. Pat. No. 6,494,943 (Yu et al.), U.S. Pat. No. 6,280,513 (Osumi et al.), U.S. Pat. No. 6,506,239 (Osumi et al.), U.S. Pat. No. 6,503,311 (Karl et al.), U.S. Pat. No. 6,852,156 (Yeh et al.), and U.S. Pat. No. 6,488,753 (Ito et al.), the disclosures of which are incorporated herein by reference, and in EP 1,479,732 A1 (Itoh et al.).

Also useful in the invention as supplemental colorants are polymeric dyes or loaded-dye/latex particles. Examples of polymeric dyes are described in U.S. Pat. No. 6,457,822 (Chen et al.) and references therein. Examples of loaded-dye/latex particles are described in U.S. Pat. No. 6,431,700 (Chen et al.), and U.S. Patent Application Publications 2004/0186199 (Wang et al.), 2004/0186198 (Potenza et al.), 2004/0068029 (Wang et al.), 2003/0119984 (Wang et al.), and 2003/0119938 (Wang et al.).

The aqueous ink jet printer ink composition of this invention can also comprise one or more polymer additives distinct from any dispersants used to disperse the non-polymeric fluorescent pigments, in order to increase the stability of the non-polymeric fluorescent pigments to shear in a CIJ fluid system. The polymer additives can be water-soluble or water-dispersible and can comprise one or more water soluble copolymers, each having block segments or random segments comprised of styrene and acrylic monomers, and a molecular weight greater than 1,000. The water-soluble or water-dispersible polymer additives can have a weight average molecular weight (M_{w}) of at least 1,000 up to and including 100,000 or typically of at least 1,000 and up to and including 50,000. Such water-soluble polymer additives can comprise one or more polystyrene or substituted polystyrene chains copolymerized with other acrylate or substituted acrylate monomers or attached to another species. In one embodiment, the water-soluble polymer additive can comprise a copolymer randomly derived from styrene, alpha-methylstyrene, acrylic acid, and trisethylenoxyacrylate, in various molar ratios of recurring units.

Other examples of useful polymer additives are described in U.S. Publication Patent Application 2001-0122180 (Cook et al.), the disclosure of which is incorporated herein by reference, which water-soluble polymer additives have random or block segments comprised of styrene and acrylic monomers and a weight average molecular weight greater than 1,000.

Still other useful polymer additives are described in U.S. Patent Application Publication 2011/0123714 (Yau et al.), the disclosure of which is incorporated herein by reference, which polymer additives are water-soluble block copolymers having one or more poly(ethylene oxide) block segments having a weight average molecular weight greater than 500.

The water-soluble or water-dispersible polymer additive can be present in the aqueous ink jet printer ink compositions of this invention in an amount effective to stabilize the composition against shear induced agglomeration caused by pumping the composition through a continuous ink jet printing fluid system, but not to substantially displace any dispersant used to disperse the non-polymeric fluorescent pigments in the composition.

The concentration of the polymer additive is generally at least 0.05 weight % and up to and including 5 weight % or at least 0.1 weight % and up to and including 3 weight %, based on the total composition weight. For example, a styrene-acrylic copolymer additive can be present at a weight ratio of at least 1:10 and to and including 1:2, and more likely of at least 1:6 and to and including 1:3 relative to the dispersed non-polymeric fluorescent pigment(s).

The aqueous ink jet printer ink composition of this invention desirably contains water as the principal aqueous medium, and besides the components described above, it can optionally include one or more humectants, biocides, and surfactants, film-forming binders or mordants, solubilizing agents, co-solvents, bases, acids, pH buffers, wetting agents, chelating agents, corrosion inhibitors, viscosity modifiers, penetrants, wetting agents, antifoamants, defoamers, antifungal agents, jetting aids, filament length modifiers, trace multivalent cationic flocculating salts, thickeners, conductivity enhancing agents, drying agents, waterfastness agents, dye solubilizers, chelating agents, binders, light stabilizers, viscosifiers, anti-curl agents, anti-corrosion agents, stabilizers, or solution conductivity control agents. Examples of all of these optional components and useful amounts are known in the art.

For example, any water-soluble humectant known in the ink jet art that is compatible with the other requirements of the invention can be used. By water-soluble is meant that a mixture of the employed humectant(s) and water is homogeneous. While an individual humectant can be employed, useful compositions of this invention contain two or more humectants, each of which imparts a useful property to the composition. Representative examples of humectants and co-solvents useful in the compositions of this invention include but are not limited to:

(1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol,

(2) polyhydric alcohols, such as ethylene glycol, diethylene glycol, triethylene glycol, tetraethylene glycol, propylene glycol, dipropyleneglycol, the polyethylene glycols with average molecular weights of at least 200 to and including 5000 Daltons, the polypropylene glycols with average molecular weights of at least 200 to and including 5000 Daltons, 1,2-propanediol, 1,3-propanediol, 1,2-butanediol, 1,3-butanediol, 1,4-butanediol, 1,2,4-butanetriol, 3-methyl-1,3-butanediol, 2-methyl-1,3-propanediol, 1,5-pentanediol, 1,6-hexanediol, 2-methyl-2,4-pentanediol, 1,7-heptanediol, 2-ethyl-1,3-hexane diol, 2,2,4-trimethyl-1,3-pentane diol, 1,8-octane dial, glycerol, 1,2,6-hexanetriol, 2-ethyl-2-hydroxymethyl-propanediol, 2-methyl-2-hydroxymethyl-propanediol, saccharides and sugar alcohols and thioglycol,

(3) polyoxygenated polyols and their derivatives such as diglycerol, polyglycerols, glycerol ethoxides, glycerol propoxides, glyceryths, alkylated and acetylated glyceryths, pentaerythritol, pentaerythritol ethoxides, and pentaerythritol propoxides and their alkylated and acetylated derivatives,

(4) nitrogen-containing compounds such as urea, 2-pyrrolidone, N-methyl-2-pyrrolidone, imidazolidinone, N-hydroxyethyl acetamide, N-hydroxyethyl-2-pyrrolidinone, 1-(hydroxyethyl)-1,3-imidazolidinone, 1,3-dimethyl-2-imidazolidinone, and 1,3-dihydroxy-2-imidazolidinone,

(5) sulfur-containing compounds such as 2,2′-thiodiethanol, dimethyl sulfoxide and tetramethylene sulfone, and

(6) water soluble N-oxides such as 4-methylmorpholine-N-oxides.

Of these compounds, glycerol and the polyhydric alcohol derivatives thereof are particularly useful. The polyhydric alcohol derivatives of glycerol include the glycerol ethoxides, glycerol propoxides, and glyceryths. The humectant can be employed alone or in combination with one or more additional listed humectants. The useful humectants have melting points below the typical operating temperature of the intended printer system to avoid the formation of crystalline deposits on the print head or in the maintenance system. Practically, this means that the useful humectants have melting points below 30° C. or even below 20° C.

The total humectant level in the aqueous ink jet printer ink composition of the present invention is desirably at least 0.1 weight % and up to and including 10 weight %, or typically at least 1 weight % and up to and including 8 weight % based on the total composition weight. The total humectant amount in the composition is the sum of the individual sources of humectant ingredients, which may include humectants added directly during composition formulation, and humectants associated with a commercial biocide preparation as a supplemental ingredient, or with any other commercial component added to the composition.

The pH of the aqueous ink jet printer ink compositions of this invention may be adjusted by the addition of organic or inorganic acids or bases. The pH of the composition is desirably adjusted to at least 7 and up to and including 12 or more likely at least 8 and up to and including 10. An anticorrosion inhibitor such as the sodium salt of 4- or 5-methyl-1-H-benzotriazole is desirably added and the pH adjusted to be at least 10 and up to and including 11. When the composition is used with print heads having components fabricated from silicon that are in contact with the composition, the composition pH is desirably adjusted to be at least 7 and up to and including 9.5 or at least 7.5 and up to and including 9. In order to minimize the risk of excessively protonating carboxylate anions associated with polymeric dispersants and anionic charge stabilized anti-abrasion polymers that might render the composition more susceptible to flocculation, pH levels lower than 7 are usually avoided. With hardware components fabricated from silicon in contact with the composition, pH levels of at least 10 can induce significant rates of etch and corrosion that can impair the operation of the device over time. Typical useful inorganic acids include but are not limited to, nitric acid, hydrochloric acid, phosphoric acid, and sulfuric acids. Typical useful organic acids include but are not limited to, methanesulfonic acid, acetic acid, formic acid, and lactic acid. Typical useful inorganic bases include but are not limited to, alkali metal hydroxides and carbonates. Typical useful organic bases include but are not limited to, ammonia, triethanolamine, and tetramethylethlenediamine. Amine bases especially useful include 3-amino-1-propanol, N,N-dimethanolamine, N,N-dimethylethanolamine, N,N-diethylethanolamine, and triethanolamine. The known Goods buffers can also be employed. The amount of useful acid, base, or buffer to be used in the composition of this invention would be readily apparent to one skilled in the art.

In some embodiments, the composition of this invention can also comprise an acidic salt of an organic amine and additional free organic amine, as described for example in U.S. Patent Application Publication 2010/0304028 (Sowinski et al.), the disclosure of which is incorporated herein by reference. The incorporation of the acidic salt of an organic amine and additional free organic amine can provide buffering at a pH of at least 8 and a resistivity of the composition of less than 700 ohm-cm at 25° C. The ratio of equivalents of organic amine to equivalents of acid used to form the acidic salt of the organic amine is generally at least 1.1:1. This control of the composition resistivity can be useful when the aqueous ink jet printer ink is recycled from a main fluid supply and using an ink jet printer having a composition delivery system that is capable of measuring composition conductivity as a means for determining when additional supply of composition (replenisher composition or fresh composition) is to be added to the main fluid supply to maintain desired recycled composition concentration. The electrical conductivity of the composition can be measured by applying an electrical potential across two electrodes immersed in the composition and using Ohm's law. Further details are provided in the cited U.S. Patent Application Publication 2010/0304028 (noted above).

The aqueous ink jet printer ink compositions of the invention can contain surfactants adjust the static surface tension or dynamic surface tension of the composition to an appropriate level. Useful surfactants can be anionic, cationic, amphoteric, or nonionic in nature and used at amounts of at least 0.01 weight % and up to and including 5 weight % based on the total weight of the composition.

Defoaming agents comprised of phosphate esters, polysiloxanes, or acetylenic diols can also be included in the compositions of this invention to minimize foam formation caused by the fluid agitation associated with drop catching and composition recirculation.

A biocide can be included in the composition of this invention to suppress the growth of microorganisms such as molds and fungi. A useful biocide is commercially available as Proxel® GXL (Zeneca Specialties Co.) and this or another biocide can be included at a final concentration of at least 0.0001 weight % and up to and including 0.5 weight % based on the total composition weight.

The exact choice of essential component (non-polymeric fluorescent pigment particles and water) and optional components (described above) in the composition of this invention will depend upon the specific application and performance requirements of the ink jet print head from which the composition is to be jetted. For some embodiments of continuous ink jet ejection mode, acceptable composition viscosities are at least 0.9 cps (centipoises) and up to and including 10 cps, or typically at least 0.9 cps and up to and including 5 cps, as measured at 25° C. using a capillary viscometer.

In many embodiments of this invention, the composition has a resistivity of less than 700 ohm-cm as determined by measuring composition conductivity using a conductivity meter, and then converting the conductivity to resistivity using known mathematical relationships.

Some embodiments of the aqueous ink jet printer ink compositions of the invention are designed specifically for use in a continuous ink jet printer, in which a main fluid supply is provided with a desired amount of the composition, which is then pumped from the main fluid supply to a drop generator mechanism such as one or more ink jet print heads, where a continuous stream of the composition is ejected from the drop generator mechanism, which continuous stream then is broken into spaced drops.

In response to electrical signals received from a suitable control mechanism, the spaced drops are then selected or controlled between printing drops for marking a receiver element and non-printing drops that are collected and returned to the main fluid supply. For example, the printing drops and non-printing drops can be differentiated by drop size. Some of the details of these actions are described more fully for example in U.S. Pat. No. 4,734,711 (Piatt et al.), U.S. Pat. No. 5,394,177 (McCann et al.), U.S. Pat. No. 6,588,888 (noted above), U.S. Pat. No. 6,943,037 (noted above), U.S. Pat. No. 4,614,948 (Katerberg et al.), and U.S. Pat. No. 4,971,527 (Dick), and EP 1,013,450 (Enz et al.), the disclosures of which are incorporated by reference herein. In contrast to drop-on-demand printing, CIJ is a very high speed printing process and it is desired to operate at substrate transport speeds in excess of 200 m/min. Printing speed alone imposes some limitations on composition formulation relative to slower drop-on-demand printing techniques, simply on the basis of the short time requirements for adequately drying the printed receiver element moving at full speed in the printing press before roll wind-up. Surprisingly, features of CIJ print head operation can allow wider composition formulation latitude than is possible in DOD printing in other respects. Composition formulation considerations specific to CIJ printing are described in W. Wnek, IEEE Trans. 1986, 1475-81, which describes the composition performance requirements for drop formation, deflection, and catching of non-printing drops, recirculation of the composition to the drip generator mechanism from the main fluid supply for future printing, and also for commercial image quality and durability.

One sub-system common to most CIJ apparatus and methods and to some of the more recent DOD printing systems, is a recirculating fluid system, which constantly recirculates the ink. For these types of ink jet printing systems the median particle size of the non-polymeric fluorescent pigments and the overall stability of the pigment particle dispersion, are critical features due the potentially abrasive nature of pigment particle dispersions. Larger particles or less stable particle dispersions are more prone to cause premature wear or failure of the components of the ink jet printing system and fluid sub-system.

In some embodiment of the present invention, the aqueous ink jet printer ink composition is printed by employing a plurality of drop volumes (or drop size) formed from the continuous fluid stream, with non-printing drops of a different volume than printing drops being diverted by a drop deflection means into a gutter for recirculation, as disclosed for example in U.S. Pat. No. 6,588,888 (noted above), U.S. Pat. No. 6,554,410 (Jeanmaire et al.), U.S. Pat. No. 6,682,182 (Jeanmaire et al.), U.S. Pat. No. 6,793,328 (Jeanmaire), U.S. Pat. No. 6,517,197 (Hawkins et al.), U.S. Pat. No. 6,866,370 (Jeanmaire), and U.S. Pat. No. 6,575,566 (Jeanmaire et al.), U.S. Patent Application Publication 2003/0202054 (Jeanmaire et al.) the disclosures of which are herein incorporated by reference.

In another embodiment, the aqueous ink jet printer ink composition is printed onto a receiver element using an apparatus capable of controlling the direction of the formed printing and non-printing drops by asymmetric application of heat to the continuous stream of the composition that initializes drop break-up and serves to steer the resultant drops, as disclosed for example in U.S. Pat. No. 6,079,821 (Chwalek et al.) and U.S. Pat. No. 6,505,921 (Chwalek et al.), the disclosures of which are herein incorporated by reference. Useful agitation of the composition, heated main fluid supply, and ink jet print head and composition filtration means for CIJ ink compositions are described for example in U.S. Pat. No. 6,817,705 (Crockett et al.), the disclosure of which is incorporated herein by reference. Printer replenishing systems for maintaining quality of the composition and countering the effects of volatile component evaporation are described in U.S. Pat. No. 5,526,026 (Bowers) and U.S. Pat. No. 5,473,350 (Mader et al.), the disclosures of which are incorporated herein by reference, and in EP 0 597 628 A 1 (Loyd et al.).

It can be useful to regularly replenish the main fluid supply with additional aqueous ink jet printer ink composition of this invention to keep the reservoir at the desired level during ink jet printing. Alternatively, water can be added to the main fluid supply to compensate for water that is evaporated during inkjet printing. A skilled worker in the art would understand how to accomplish these operations using the teaching provided in the art noted above.

The present invention can be used to provide continuous ink jet printer images with desired amount of fluorescent pigments, so the image is suitably detectable using appropriate means (described below), on a variety of substrates or receiver elements, including but not limited to, the normal mix of paper substrates such as plain bond papers, surface-treated papers, coated or calendared business gloss papers, resin-coated papers, laminated substrates comprising both paper layers and polymeric film layers such as polyester film layers, and heavy stock papers. It is also possible to “print” the composition of this invention on fabrics, cardboard, plastic films (such as polyester films), microporous materials, and any other receiver element material on which a fluorescent image is desired. The receiver element can be transparent, translucent, or opaque.

For example, useful receiver elements that could be marked according to this invention with a security mark using the aqueous ink jet printer ink composition of this invention include but are not limited to, papers used for computer printers, currency, passports and other identification papers, bonds and other security instruments, glass, rubber, vinyl plastics, fabrics, metals, and woods.

The durability and other properties of a printed fluorescent ink jet printer ink image according to this invention can be improved by using receiver elements that have been pretreated with a composition to enhance the quality of fluorescent ink jet printer image. This pretreatment is typically done prior to incorporation of the receiver element into the ink jet printing apparatus (such as a continuous ink jet printing apparatus), but in some instances, the receiver element could be pretreated within the apparatus before application of the composition of this invention. One or both sides of a receiver element can be pretreated, or one side can be pretreated and the opposite surface left untreated.

For example, the receiver element can be pretreated to form a “pretreated receiver element” by application of an overcoat (usually colorless), for example as described in U.S. Pat. No. 7,219,989 (Uerz et al.), the disclosure of which is incorporated herein by reference. In order to achieve higher print speeds and throughput, an overcoat composition can be applied using a continuous ink jet print head following in-line with one or more drop generator mechanisms (print head) that applies (prints) the composition of the present invention, with or without application of additional ink jet printer ink compositions that may comprise colored non-fluorescent pigments. Thus, the ink jet printer apparatus can comprise multiple ink jet print heads, some of which provide the fluorescent image according to the present invention, others that provide non-fluorescent colored images, and still others that pretreat the receiver elements. Thus, an ink jet printer image can be provided that has both colored portions as well as non-colored, fluorescent portions, or optionally colored portions that also contain printed fluorescent images.

The drop size, addressability, and printed resolution of an overcoat composition are not required to be the same as the printed ink jet compositions, and differing continuous inkjet print head technologies can be used as long as desired receiver element transport speeds are achieved. The overcoat composition can further comprise an acidic organic amine salt and an organic amine that are present in concentrations and in relative proportion to provide a buffered pH of at least 8 and a resistivity less than 700 ohm-cm, for example as described above for the aqueous inkjet printer ink composition of this invention.

In addition, a receiver element can be pretreated with a pretreatment composition comprising a water-soluble multivalent metal ion salt, such as but not limited to, salt comprising one or more multivalent cations including calcium, magnesium, barium, zinc, and aluminum cations, with calcium and magnesium cations being particularly useful. Examples of useful multivalent metal ion salts include but are not limited to, calcium chloride, calcium acetate, calcium nitrate, magnesium chloride, magnesium acetate, magnesium nitrate, barium chloride, barium nitrate, zinc chloride, zinc nitrate, aluminum chloride, aluminum hydroxychloride, and aluminum nitrate. Other useful salts could be determined by a skilled artisan, and one or more of such multivalent metal ion salts can be used in the pretreatment composition in an amount that would be readily apparent to one skilled in the art.

Such pretreatment compositions can also comprise a cationic polyelectrolyte comprising amidine moieties, and the details of such compounds and their useful amounts are provided in copending and commonly assigned U.S. patent application Ser. No. 13/433,412 (filed Mar. 29, 2012 by Xiang and Botros), the disclosure of which is incorporated herein by reference.

Besides applying the pretreatment composition using an ink jet printer apparatus (such as a continuous ink jet printer apparatus), it can also be applied using other mechanical techniques including but not limited to, rod coating, blade coating, gravure coating, flexographic printing, extrusion hopper coating, curtain coating, and spray coating. After the pretreatment composition is dried, the pretreated receiver element can be calendered to improve gloss.

Once the aqueous ink jet printer ink composition of this invention has been applied (printed) onto a suitable receiver element, the receiver element is then “marked” with the non-polymeric fluorescent particles for detection of the fluorescent image at a later time, whether for security or other purposes. Of course, as noted above, the “colorless fluorescent” image can also have color images with it as provided by non-fluorescent colored pigments or dyes, but the detection of the fluorescent image within, about, above, or otherwise provided on the receiver element is the primary purpose of the present invention.

The printed receiver element can be a suitable article, including but not limited to, documents, paper currency, postage stamps, packaging, fabric, polymeric film or sheet, label for clothing, perfume, wine bottles, lottery tickets, passports, drivers licenses, and other articles mentioned above in the Background or which would be readily apparent to one skilled in the art using the teaching provided herein.

The fluorescent image can be suitably detected using any device that is designed to irradiate the article or receiver element with radiation having a peak wavelength of at least 300 nm and up to and including 400 nm (typically ultraviolet light irradiation having a peak wavelength of at least 350 nm), and then to detect a fluorescing emission peak that is greater than 400 nm and up to and including 700 nm (for example in a particular region of this visible range of the electromagnetic spectrum). Such devices are known in the art, and their use would be readily understood by a skilled worker and others could be easily trained to use them when it was desired to detect the distinct fluorescing emission (for example, a red fluorescing image). Data from the detection of the visible fluorescing emission can be stored or transmitted using suitable digital means.

For example, a method for identifying an object using security mark can comprise:

applying a security mark to an object using the aqueous ink jet printer ink composition of this invention, for example using continuous ink jet processes and equipment, to form a marked object,

exposing the marked object to a fluorescent-exciting radiation having an excitation peak wavelength of at least 300 nm and less than 400 nm,

detecting the security mark on the marked object by detecting a fluorescent emission at an emission peak that is greater than 400 nm and up to and including 700 nm, and

identifying the security mark in response to detecting the security mark on the marked object.

Exposing an object and detection of a security mark such as a bar code, UPC code binary data, alphanumeric data, textual data, numeric data, and data encoded in other formats, and other embodiments of the method of this invention can be carried out using suitable equipment that are known in the art and available from various commercial sources. For example, detection means include but are not limited to, LED emitters and appropriate sensors, and fluorescence spectrophotometers.

The present invention provides at least the following embodiments and combinations thereof, but other combinations of features are considered to be within the present invention as a skilled artisan would appreciate from the teaching of this disclosure:

1. An aqueous ink jet printer ink composition consisting essentially of;

non-polymeric fluorescent pigment particles that have (1) an excitation peak wavelength of at least 300 nm and less than 400 nm, and (2) an emission peak that is greater than 400 nm and up to and including 700 nm when exposed to fluorescent-exciting radiation, and

an aqueous medium comprising water,

wherein the non-polymeric fluorescent pigment particles have a median particle size that is greater than 10 nm and up to and including 500 nm, and the 95^{th} percentile fluorescent pigment particle size is less than 150 nm.

2. An aqueous ink jet printer ink composition consisting essentially of:

non-polymeric fluorescent pigment particles that have (1) an excitation peak wavelength of at least 300 nm and less than 400 nm, and (2) an emission peak that is greater than 400 nm and up to and including 700 nm when exposed to fluorescent-exciting radiation,

one or more colored, non-fluorescent pigment particles other than carbon black, having a median particle size of at least 10 nm and up to and including 200 nm, and

an aqueous medium comprising water,

wherein the non-polymeric fluorescent pigment particles have a median particle size that is greater than 10 nm and up to and including 500 nm, and the 95^{th} percentile fluorescent pigment particle size is less than 150 nm.

3. The composition of embodiment 1 or 2, wherein the non-polymeric fluorescent pigment particles are colorless.

4. The composition of any of embodiments 1 to 3, wherein the non-polymeric fluorescent pigment particles have a median particle size that is greater than 10 nm and up to and including 200 nm.

5. The composition of any of embodiments 1 to 4, wherein the non-polymeric fluorescent pigment particles have an excitation peak wavelength of at least 320 nm and less than 380 nm, and have an emission peak of that is greater than 400 nm and up to and including 700 nm when exposed to fluorescence-exciting radiation.

6. The composition of any of embodiments 1 to 5, wherein the non-polymeric fluorescent pigment particles are the only pigment particles in the aqueous ink jet printer ink composition.

7. The composition of any of embodiments 1 to 6, having two or more distinct non-polymeric fluorescent pigment particles, the distinct non-polymeric fluorescent pigment particles having either:

(a) the same excitation peak wavelength of at least 300 nm and less than 400 nm, and different emission peaks that are greater than 400 nm and up to and including 700 nm when exposed to fluorescence-exciting radiation, or

(b) different excitation peak wavelengths that are at least 300 nm and less than 400 nm, and the same emission peak that is greater than 400 nm and up to and including 700 nm when exposed to fluorescence-exciting radiation.

8. The composition of any of embodiments 1 to 7 having a viscosity of at least 0.9 cps and up to and including 5 cps.

9. The composition of any of embodiments 1 to 8, wherein the non-polymeric fluorescent pigment particles are present in an amount of at least 0.1 weight % and up to and including 10 weight %.

10. The composition of any of embodiments 1 to 9, wherein the non-polymeric fluorescent pigment particles are dispersed in the presence of a dispersant that is present in the composition in an amount sufficient to provide a weight ratio of dispersant to non-polymeric fluorescent pigment particles of at least 1:4 and to and including 1:2.

11. The composition of any of embodiments 1 to 10 having a resistivity of less than 700 ohm-cm.

12. The composition of any of embodiments 1 to 11, further including a polymer additive in an amount of at least 0.5 weight % and up to and including 5 weight %.

13. The composition of any of embodiments 1 to 12, which is designed for continuous recirculation in an ink jet printer.

14. A method of ink jet printing, comprising:

providing a main fluid supply of the aqueous ink jet printer ink composition of any of embodiments 1 to 13,

pumping the aqueous ink jet printer ink composition from the main fluid supply to a drop generator mechanism, and ejecting a continuous stream of the aqueous ink jet printer ink composition from the drop generator mechanism, which continuous stream is broken into spaced drops, and

in response to electrical signals received from a control mechanism, controlling the spaced drops to differentiate between printing drops for marking a receiver element and non-printing drops that are collected and returned to the main fluid supply.

15. The method of embodiment 14, comprising differentiating between the printing drops and the non-printing drops by drop size.

16. The method of embodiment 14 or 15, wherein the drop generating mechanism is an ink jet print head.

17. The method of any of embodiments 14 to 16, wherein the receiver element has been pretreated with a composition to enhance the quality of ink jet printer image.

18. The method of any of embodiments 14 to 17 that is continuous ink jet printing.

19. A method of ink jet printing, comprising:

providing a main fluid supply of the aqueous ink jet printer ink composition of any of embodiments 1 to 13,

pumping the aqueous ink jet printer ink composition from the main fluid supply to a drop generator mechanism, and ejecting a continuous stream of the aqueous ink jet printer ink composition from the drop generator mechanism, which continuous stream is broken into spaced drops, and

in response to electrical signals received from a control mechanism, controlling the spaced drops to differentiate between printing drops for marking a receiver element and non-printing drops that are collected and returned to the main fluid supply.

20. A method for forming an image, the method comprising ink jet printing a receiver element with the aqueous ink jet printer ink composition of any of embodiments 1 to 13, using an ink jet printer.

21. The method of embodiment 20, wherein the method further comprises continuously recirculating unused aqueous ink jet printer ink composition to the ink jet printer.

22. A receiver element that is printed according to the method of any of embodiments 14 to 21, and having thereon an ink jet printed image comprising non-polymeric fluorescent pigment particles that have (1) an excitation peak wavelength of at least 300 nm and less than 400 nm, and (2) an emission peak that is greater than 400 nm and up to and including 700 nm when exposed to fluorescence-exciting radiation.

23. The receiver element of embodiment 22 that is a pretreated receiver element that has been pretreated with a water-soluble multivalent metal ion salt to provide the pretreated receiver element.

24. A method of detecting a fluorescent image, comprising:

irradiating an article with radiation having a peak wavelength of at least 300 nm and up to and including 400 nm, the article comprising an ink jet printed image obtained using the aqueous ink jet printer ink composition of any of embodiments 1 to 13.

The following Examples are provided to illustrate the practice of this invention and are not meant to be limiting in any manner. Percentages are in weight % based on total composition weight, unless otherwise indicated.

### Invention Example 1

An aqueous ink jet printer ink composition of this invention was prepared using the following Formulation 1:

333 g of high purity or deionized water,

75 g of LUREDP8 fluorescent pigment (LUMINOCHEM, Budapest), having excitation wavelength of 365 nm and an emission wavelength of from 550 nm to 600 nm,

170 g of poly(benzyl methacrylate-co-n-octadecyl methacrylate-co-methacrylic acid) with dimethylethanolamine neutralizer, 15%, CIN 10093164),

2 g of Surfynol® 440 surfactant (Air Products & Chemicals),

0.5 g Kordek™ MLX biocide (Rohm & Haas), and

500 g of Micromedia SDY50 milling media (50 μm polystyrene beads, Eastman Kodak Company).

All materials of Formulation 1 were charged to a 2 liter, jacketed beaker equipped with a Cowles Disperser, and then agitated at 4000 rpm and kept at an initial temperature of 22° C. After about 5 hours of agitation, a particle size analysis (Nanotrac) determined a median particle size (Mₙ) of 125 nm, and a 95^{th} percentile particle size of 301 nm. After about 20 hours, the temperature was raised to 64° C. The dispersion was then cooled using domestic water circulating through the beaker jacket. A particle size analysis after 24 hours found an Mₙ of 52 nm, and a 95^{th} percentile particle size of 127 nm. The dispersion was then filtered through a 300 mesh wire screen to remove the aqueous medium. The remaining dispersion was then filtered through a 0.45 μm Ultipor® GF filter cartridge (PALL Corp.) to provide an aqueous inkjet printer ink composition of this invention.

### Comparative Example 1

A comparative aqueous ink jet printer ink composition was prepared using the following Formulation 2:

40 g of aluminum acetate (˜19% Al, Sigma-Aldrich Catalog No. 294853),

2500 g of high purity or deionized water,

9.0 g of Pyranine 100 Solution of fluorescent dye (Keystone Aniline) having an excitation wavelength of 250-260 nm and an emission wavelength of from 400-500 nm, and

40 g of a 45% aqueous potassium hydroxide solution (Sigma-Aldrich).

To prepare a fluorescent pigment dispersion, the aluminum acetate and water were combined and stirred until a clear solution was obtained. The Pyranine 10G Solution was then added and the stirring speed was increased to about 1000 rpm, and 22 g of a 45% potassium hydroxide solution was added over about 10 minutes to reach a pH of 8.08. The resulting mixture gelled at this pH value. After about 10 minutes, the pH had drifted down to 7.9 and about 8 g of additional 45% potassium hydroxide solution were added to move the pH back to 8.0. This mixture was filtered under 25 inches (63.5 cm) of Mercury vacuum on an 18.5 cm Buchner funnel with Whatman #1 qualitative filter paper.

To prepare a pigment dispersion formulation, 645 g of water wet filter cake of Pyranine 10G Aluminum Hydroxide Lake (as prepared above), 160 g of Joncryl® HPD-696/KOH Solution (Joncryl® HPD-696 from BASF, KOH neutralized solution from Eastman Kodak Company, 20 g of Zetasperse® 1600 (Air Products & Chemicals), 200 g of Micromedia SDY50 (50 μm polystyrene beads from Eastman Kodak Company), and 300 g of high purity or deionized water were mixed.

All of the components listed above were combined in a 2 liter jacketed flask equipped with a Cowles Dissolver. The noted dispersion was stirred for about 15 minutes until uniform and then the polystyrene beads were added. The resulting mixture was treated with 200 grams of the polystyrene beads and the combined mixture was agitated at 4000 rpm for 80 hours. The resulting median particle size of the resulting dispersion (Mₙ) was 129 nm and the 95^{th} percentile was 344 nm. The polystyrene beads were filtered from the dispersion using a 300 mesh wire screen.

### Invention Example 2

The following components were combined:

607 g of high purity or deionized water,

4.0 g of dimethyl ethanolamine (Univar),

8.0 g of 25% aqueous acetic acid (Ashland),

55.0 g of triethylene glycol (Dow Chemical),

10.0 g of Joncryl® HPD-696/potassium hydroxide solution (BASF/Eastman Kodak Company),

1 g of Cobratec® TT50S (PMC Specialties),

1 g of Kordek™ MLX biocide (Rohm & Haas),

2 g of Proxel GXL biocide (Arch Chemicals),

2 g of Surfynol® 440 surfactant (Air Products & Chemicals),

80 g of LUREDP8 Dispersion (13% fluorescent pigment; dispersion prepared in Invention Example 1),

142 g of Chromphthal 2BC magenta dispersion (BASF/Eastman Kodak Company), and

87 g of Pigment Yellow 74 Dispersion (SUN Chemical/Eastman Kodak).

All of these materials were combined in a stirred beaker and mixed for 30 minutes. The resulting aqueous inkjet printer ink was filtered through a 0.45 μm Pall WFN filter cartridge.

### Comparative Example 2

The following components were combined:

607 g of high purity or deionized water,

4.0 g of dimethyl ethanolamine (Univar),

8.0 g of 25% aqueous acetic acid (Ashland),

55.0 g of triethylene glycol (Dow Chemical),

10.0 g of Joncryl® HPD-696/potassium hydroxide solution (BASF/Eastman Kodak Company),

1 g of Cobratec® TT50S (PMC Specialties),

1 g of Kordek™ MLX biocide (Rohm & Haas),

2 g of Proxel GXL biocide (Arch Chemicals),

2 g of Surfynol® 440 surfactant (Air Products & Chemicals),

80 g of Pyranine 10G-Aluminum Hydroxide Dispersion (Pigment Dispersion #2 above), and

142 g of Chromphthal 2BC magenta dispersion (Eastman Kodak Company).

All of the above materials were combined in a stirred beaker and mixed for 30 minutes. The resulting ink was filtered through a 0.45 μm Pall WFN filter cartridge.

### Evaluation of Invention Example 2 and Comparative Example 2

Both compositions were drawn down using a #4 Meier (wire-wound) rod onto both bond and glossy papers. Invention Example 2 was excited at 360-400 nm while Comparative Example 2 was excited at 250-260 nm. The following emission results were observed:

| Composition | Visible Color | Fluorescence |
|---|---|---|
| Invention Example 2 | Orange | Yes- bright red |
| Comparative Example 2 | Orange | None |

These results show that fluorescent moieties used in combination with standard colorants (dyes or pigments) may not exhibit useful fluorescence according to the present invention. This effect may be due to simple absorbance of UV light in non-fluorescing electron transitions that quenches the fluorescence electron transitions. For example, most colored pigments exhibit non-fluorescing absorbance at about 250 nm. Fluorescent pigments used in the practice of this invention with excitation absorbance wavelengths of 300-400 nm are less effected by non-fluorescing electron transitions and hence exhibit useful fluorescence in the presence of visible colored pigments.

### Invention Example 3

The following components were combined:

876 g of high purity or deionized water,

4.0 g of dimethyl ethanolamine (Univar),

8.0 g of 25% aqueous acetic acid (Ashland),

55.0 g of triethylene glycol (Dow Chemical),

10.0 g of Joncryl® HPD-696/potassium hydroxide solution (BASF/Eastman Kodak Company),

1 g of Cobratec® TT50S (PMC Specialties),

1 g of Kordek™ MLX biocide (Rohm & Haas),

2 g of Proxel GXL biocide (Arch Chemicals),

2 g of Surfynol® 440 surfactant (Air Products & Chemicals), and

40 g of LUREDP8 Dispersion (13% fluorescent pigment dispersion prepared in Invention Example 1),

All of these materials were combined in a stirred beaker and mixed for 30 minutes. The resulting aqueous inkjet printer ink was filtered through a 0.45 μm Pall WFN filter cartridge.

The resulting colorless (invisible) aqueous ink jet printer ink composition was applied to samples of Sterling Ultragloss and IP Datajet papers. Upon excitation at 365 nm, the applied colorless composition exhibited a red color fluorescent emission.

The invention has been described in detail with particular reference to certain preferred embodiments thereof, but it will be understood that variations and modifications can be effected within the spirit and scope of the invention.

1. An aqueous ink jet printer ink composition consisting essentially of:
non-polymeric fluorescent pigment particles that have (1) an excitation peak wavelength of at least 300 nm and less than 400 nm, and (2) an emission peak that is greater than 400 nm and up to and including 700 nm when exposed to fluorescent-exciting radiation, and
an aqueous medium comprising water,
wherein the non-polymeric fluorescent pigment particles have a median particle size that is greater than 10 nm and up to and including 500 nm, and the 95^{th} percentile fluorescent pigment particle size is less than 150 nm.

2. The composition of claim 1, wherein the non-polymeric fluorescent pigment particles are colorless.

3. The composition of claim 1, wherein the non-polymeric fluorescent pigment particles have a median particle size that is greater than 10 nm and up to and including 200 nm.

4. The composition of claim 1, wherein the non-polymeric fluorescent pigment particles have an excitation peak wavelength of at least 320 nm and less than 380 nm, and have an emission peak of that is greater than 400 nm and up to and including 700 nm when exposed to fluorescence-exciting radiation.

5. The composition of claim 1, wherein the non-polymeric fluorescent pigment particles are the only pigment particles in the aqueous ink jet printer ink composition.

6. The composition of claim 1, having two or more distinct non-polymeric fluorescent pigment particles, the distinct non-polymeric fluorescent pigment particles having either:
(a) the same excitation peak wavelength of at least 300 nm and less than 400 nm, and different emission peaks that are greater than 400 nm and up to and including 700 nm when exposed to fluorescence-exciting radiation, or
(b) different excitation peak wavelengths that are at least 300 nm and less than 400 nm, and the same emission peak that is greater than 400 nm and up to and including 700 nm when exposed to fluorescence-exciting radiation.

7. The composition of claim 1 having a viscosity of at least 0.9 cps and up to and including 5 cps.

8. The composition of claim 1, wherein the non-polymeric fluorescent pigment particles are present in an amount of at least 0.1 weight % and up to and including 10 weight %.

9. The composition of claim 1, wherein the non-polymeric fluorescent pigment particles are dispersed in the presence of a dispersant that is present in the composition in an amount sufficient to provide a weight ratio of dispersant to non-polymeric fluorescent pigment particles of at least 1:4 and to and including 1:2.

10. The composition of claim 1 having a resistivity of less than 700 ohm-cm.

11. The composition of claim 1, further including a polymer additive in an amount of at least 0.5 weight % and up to and including 5 weight %.

12. The composition of claim 1, which is designed for continuous recirculation in an ink jet printer.

13. An aqueous ink jet printer ink composition consisting essentially of:
non-polymeric fluorescent pigment particles that have (1) an excitation peak wavelength of at least 300 nm and less than 400 nm, and (2) an emission peak that is greater than 400 nm and up to and including 700 nm when exposed to fluorescent-exciting radiation,
one or more colored, non-fluorescent pigment particles other than carbon black, having a median particle size of at least 10 nm and up to and including 200 nm, and
an aqueous medium comprising water,
wherein the non-polymeric fluorescent pigment particles have a median particle size that is greater than 10 nm and up to and including 500 nm, and the 95^{th} percentile fluorescent pigment particle size is less than 150 nm.

14. The composition of claim 13, wherein the non-polymeric fluorescent pigment particles are colorless.

15. The composition of claim 13, wherein the non-polymeric fluorescent pigment particles have a median particle size that is greater than 10 nm and up to and including 200 nm.

16. The composition of claim 13, wherein the non-polymeric fluorescent pigment particles are present in an amount of at least 0.1 weight % and up to and including 10 weight %.

17. A method of ink jet printing, comprising:
providing a main fluid supply of the aqueous ink jet printer ink composition of claim 1,
pumping the aqueous ink jet printer ink composition from the main fluid supply to a drop generator mechanism, and ejecting a continuous stream of the aqueous ink jet printer ink composition from the drop generator mechanism, which continuous stream is broken into spaced drops, and
in response to electrical signals received from a control mechanism, controlling the spaced drops to differentiate between printing drops for marking a receiver element and non-printing drops that are collected and returned to the main fluid supply.

18. The method of claim 17, comprising differentiating between the printing drops and the non-printing drops by drop size.

19. The method of claim 17, wherein the drop generating mechanism is an ink jet print head.

20. The method of claim 17, wherein the receiver element has been pretreated with a composition to enhance the quality of ink jet printer image.

21. The method of claim 17 that is continuous ink jet printing.

22. A method of ink jet printing, comprising:
providing a main fluid supply of the aqueous ink jet printer ink composition of claim 13,
pumping the aqueous ink jet printer ink composition from the main fluid supply to a drop generator mechanism, and ejecting a continuous stream of the aqueous ink jet printer ink composition from the drop generator mechanism, which continuous stream is broken into spaced drops, and
in response to electrical signals received from a control mechanism, controlling the spaced drops to differentiate between printing drops for marking a receiver element and non-printing drops that are collected and returned to the main fluid supply.

23. A method for forming an image, the method comprising ink jet printing a receiver element with the aqueous ink jet printer ink composition of claim 1, using an ink jet printer.

24. The method of claim 23, wherein the method further comprises continuously recirculating unused aqueous ink jet printer ink composition to the ink jet printer.

25. A receiver element that is printed according to the method of claim 17, and having thereon an ink jet printed image comprising non-polymeric fluorescent pigment particles that have (1) an excitation peak wavelength of at least 300 nm and less than 400 nm, and (2) an emission peak that is greater than 400 nm and up to and including 700 nm when exposed to fluorescence-exciting radiation.

26. The receiver element of claim 25 that is a pretreated receiver element that has been pretreated with a composition to enhance the quality of the ink jet printed image, before printing the pretreated receiver element with a composition comprising the non-polymeric fluorescent pigment particles.

27. The receiver element of claim 25 that is a pretreated receiver element that has been pretreated with a water-soluble multivalent metal ion salt to provide the pretreated receiver element.

28. A method of detecting a fluorescent image, comprising:
irradiating an article with radiation having a peak wavelength of at least 300 nm and up to and including 400 nm, the article comprising an ink jet printed image obtained using the aqueous ink jet printer ink composition of claim 1.
